(19) United States
(12) Patent Application Publication
(10) Pub. No.: US 2025/0067300 A1
(43) Pub. Date: Feb. 27, 2025

(54) SEAL WASHER AND MOUNTING STRUCTURE OF THE SAME

(71) Applicant: UCHIYAMA MANUFACTURING CORP., Okayama (JP)

(72) Inventor: Kazunori EDAHIRO, Okayama (JP)

(21) Appl. No.: 18/787,612

(22) Filed: Jul. 29, 2024

(30) Foreign Application Priority Data
Aug. 25, 2023 (JP) 2023-137535

(51) Int. Cl. F16B 43/00; F16J 15/3204

(52) U.S. Cl. CPC F16B 43/001; F16J 15/3204

(57) ABSTRACT

A seal washer including an annular core member, an outer seal portion, and an inner seal portion, the core member including a core member body and a seal base. The outer seal portion is provided on one of two surfaces of the seal base in thickness direction so as to protrude further than a surface of the core member body, t. The inner seal portion is provided at an end face of the core member body on an inner peripheral side so as to protrude further than a surface of the core member body toward the fastening portion. An inner diameter of the outer seal portion is larger than a diameter of the insertion hole, a diameter of the insertion hole is larger than an inner diameter of the core member, and an outer diameter of the fastening portion is larger than the inner diameter of the core member.

### BACKGROUND OF THE INVENTION

### Field of the Invention

The present invention relates to a seal washer and its mounting structure.

### Description of the Related Art

Conventional seal washers include an annular core member, an outer seal portion made of an elastic material and fixed to the end portion of the core member on the outer peripheral side, and an inner seal portion made of an elastic material and fixed to the end portion of the core member on the inner peripheral side, referring to Patent Document 1.

In this type of seal washer, while the outer seal portion seals the space between the seal washer and a member to be fastened by elastic contact with the member to be fastened, the inner seal portion seals the space between the seal washer and a fastening portion by elastic contact with the fastening portion of the fixture, i.e., the ring washer in Patent Document 1, thereby preventing intrusion of water into the insertion hole of the member to be fastened.

### RELATED ART DOCUMENT

[Patent Document 1] WO2014/080511

### SUMMARY OF THE INVENTION

### Problems to be Solved by the Invention

According to the above-described document, in the fixation work of the member to be fastened by the fixture, when the rotation operation proceeds and the elastic contact with the member to be fastened by the outer seal portion and the elastic contact with the fastening portion by the inner seal portion proceed, the pressing force of the seal washer acts on the member to be fastened and the fixture by elastic contact, so that the fixture has difficulty in further rotation.

The present disclosure has been proposed to solve the problem above, and an object is to provide a seal washer having a high sealing performance and being capable of executing fastening operation of the fixture smoothly, and to provide a mounting structure of the seal washer.

### Means of Solving the Problems

In order to achieve the above-mentioned object, a seal washer to be provided in a space between a fastening portion of a fixture and a member to be fastened is characterized in that the fixture includes the fastening portion and a shaft portion, the member to be fastened has an insertion hole through which the shaft portion is inserted, the seal washer includes an annular core member, an outer seal portion made of an elastic material and fixed to an end portion of the core member on an outer peripheral side, and an inner seal portion made of an elastic material and fixed to an end portion of the core member on an inner peripheral side. In addition, the core member includes a core member body and a seal base extending to an outer peripheral side from the core member body, the outer seal portion is provided on one of two surfaces of the seal base in thickness direction so as to protrude further than a surface of the core member body, the one surface facing the member to be fastened, the inner seal portion is provided at an end face of the core member body on an inner peripheral side so as to further protrude inward and to protrude further than a surface of the core member body toward the fastening portion. Further, an inner diameter of the outer seal portion is larger than a diameter of the insertion hole, a diameter of the insertion hole is larger than an inner diameter of the core member, and an outer diameter of the fastening portion is larger than the inner diameter of the core member.

In an attachment structure of the seal washer according to the embodiment of the present invention, the seal washer is provided in the space between the fastening portion of the fixture and the member to be fastened, the fixture includes the fastening portion and the shaft portion, and the member to be fastened includes the insertion hole through which the shaft portion is inserted.

In the seal washer and the mounting structure of the seal washer according to the embodiments of the present invention, a combination of two or more of the following configurations (1)˜(3) can be further provided.

Configuration (1): The seal washer further includes a fitting piece protruding inward from an end face of the inner seal portion on an inner peripheral side, the fitting piece is in a shape of a plate which is thinner than the inner seal portion, and a tip end of the fitting piece is fitted to a peripheral surface of the shaft portion at least when the inner seal portion is not elastically deformed.

Configuration (2): The fitting piece is intermittently formed along a peripheral direction. Configuration (3): The shaft portion includes a screw groove and a tip end of the fitting piece is fitted to the screw groove.

### Effect of the Invention

Since the seal washer and its mounting structure of the embodiments of the present invention have the above-described configurations, the sealing performance is enhanced and the fastening operation of the fixture is performed smoothly in fastening the member to be fastened with the fixture.

### BRIEF DESCRIPTION OF THE DRAWINGS

FIG. 1a to FIG. 1c show the seal washer according to an embodiment of the present invention, FIG. 1a is a plan view of the seal washer, FIG. 1b is a fragmentary longitudinal sectional view taken along the line A-A, and FIG. 1c is a fragmentary longitudinal sectional view taken along the line A′-A′.

FIG. 2 is a cut end view and a partially enlarged view showing that the seal washer is mounted (1 of 2 in the timeline).

FIG. 3 is a cut end view and a partially enlarged view showing that the seal washer is mounted (2 of 2 in the timeline).

FIG. 4a and FIG. 4b are cut end views showing that the seal washer according to another embodiment is mounted.

FIG. 5a to FIG. 5e are cut end views showing that the seal washer according to still another embodiment is mounted.

FIG. 6a and FIG. 6b show the seal washer according to still another embodiment of the present invention, FIG. 6a is a plan view of the seal washer, and FIG. 6b is a fragmentary longitudinal sectional view taken along the line B-B.

### DESCRIPTION OF THE EMBODIMENTS

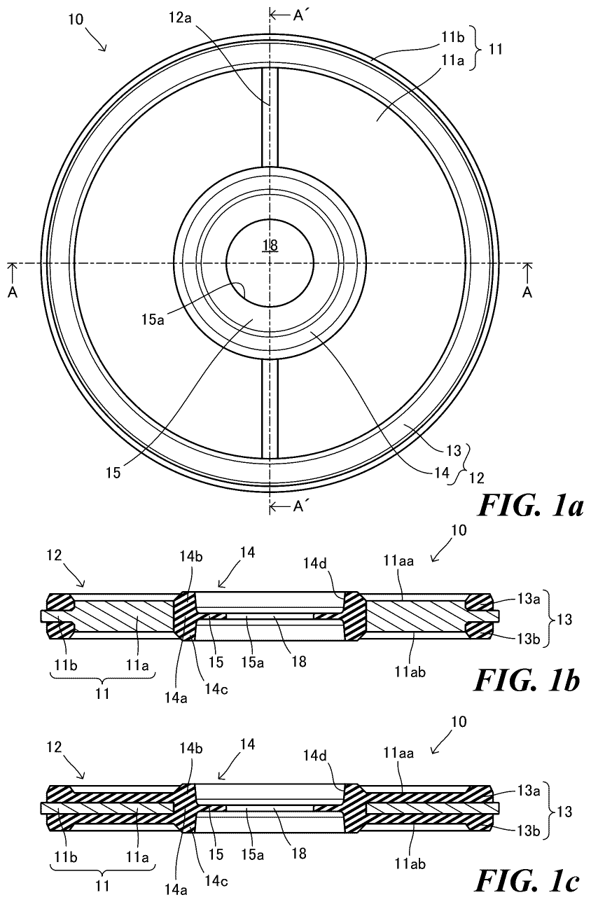

Hereinafter, embodiments of the present invention will be described with reference to the accompanying drawings. First, a common basic configuration of seal washers 10, 10A to 10G according to the embodiments illustrated in FIG. 1a to FIG. 6b will be described.

The seal washers 10, 10A to 10G are provided between a fastening portion 31 of a fixture 30 and a member to be fastened 1, the fixture 30 having the fastening portion 31 and a shaft portion 32, the member to be fastened 1 having an insertion hole 2 into which the shaft portion 32 is inserted.

The seal washers 10, 10A to 10G include an annular core member 11, an outer seal portion 13 made of an elastic material and fixed to the end portion of the core member 11 on the outer peripheral side, and an inner seal portion 14 made of an elastic material and fixed to the end portion of the core member 11 on the inner peripheral side. The core member 11 includes a core member body 11a and a seal base 11b extending from the core member main body 11a on the outer periphery side.

The outer seal portion 13 is provided on the surface facing the member to be fastened 1 of two surfaces of the seal base 11b in the thickness direction so as to protrude further than the surface 11ab (the surface on the member to be fastened side) of the core member body 11a. The inner seal portion 14 is provided at the end face of the core member body 11a on the inner peripheral side so as to further protrude inward and to protrude further than the surface 11aa (the surface on the fixture side) of the core member body 11a toward the fastening portion 31. The inner dimension r1 of the outer seal portion 13 is larger than the dimension r3 of the insertion hole 2, the dimension r3 of the insertion hole 2 is larger than the inner dimension r4 of the core member 11, and the outer dimension r2 of the fastening portion 31 is larger than the inner dimension r4 of the core member 11.

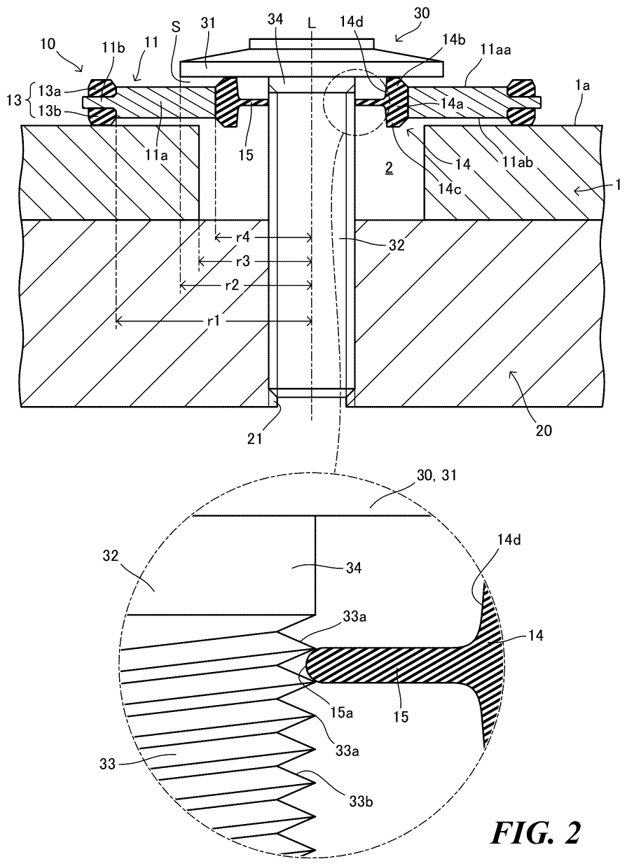

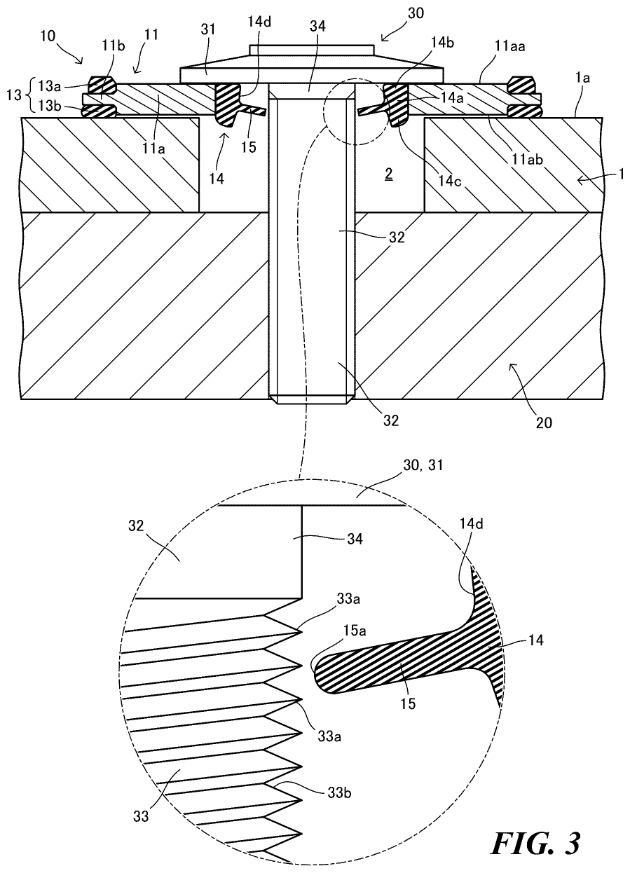

Next, the seal washer 10 and its mounting structure according to one embodiment shown in FIG. 1a to FIG. 1c will be described with reference to FIG. 1a to FIG. 3. FIG. 1a is a plan view of the seal washer 10, FIG. 1b is a fragmentary longitudinal sectional view taken along the line A-A, and FIG. 1c is a fragmentary longitudinal sectional view taken along the line A′-A′. FIG. 2 and FIG. 3 show the mounting structure of the seal washer, and FIG. 2 is a cut end view and a partially enlarged view when the seal washer 10 is mounted (1 of 2 in the timeline). FIG. 3 is a cut end view and a partially enlarged view when the seal washer 10 is mounted (2 of 2 in the timeline).

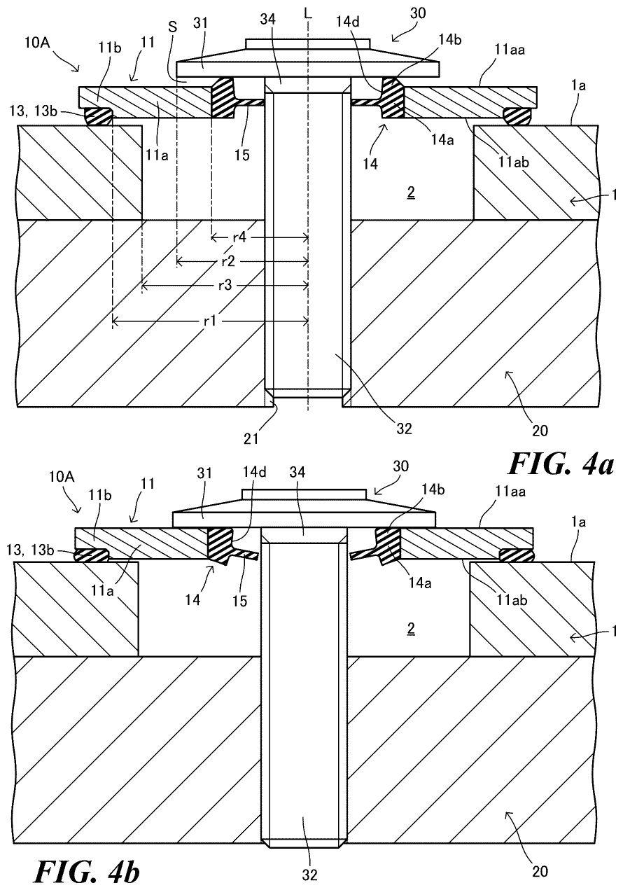

In the following description of the seal washer 10, “on the fixture side” refers to the side of the fastening portion 31 of the fixture 30 of the seal washer 10, and “on the member to be fastened side” refers to the side of the member to be fastened 1 of the seal washer 10. The same applies to the description of the seal washers 10A to 10G illustrated in FIG. 4a to FIG. 6b, which are explanatory views of another embodiment.

The seal washer 10 of FIG. 1a is an annular body as shown in FIGS. 1a and 1s integrated with the annular core member 11 made of metal, an elastic seal portion 12 made of an elastic material, and a fitting piece 15 made of an elastic material. Examples of the material of the core member 11 includes hard synthetic resin materials in addition to metal materials such as iron, copper, or aluminum. The elastic material includes rubber or a soft synthetic resin having elasticity.

The core member 11 includes the core member body 11a and the seal base 11b provided on the outer peripheral side of the core member body 11a. The core member body 11a has an approximately uniform thickness and is almost rectangular in the cross-sectional view. The seal base 11b is an annular plate piece having a thickness of about ⅓ of the core member body 11a, and is formed so as to extend approximately parallel to the core member body 11a from almost the center of the outer peripheral edge of the core member body 11a in the thickness direction.

The elastic seal portion 12 includes an outer seal portion 13 provided on the outer peripheral portion of the seal washer 10 and an inner seal portion 14 provided on the inner peripheral portion of the seal washer 10. The end face 14d on the inner peripheral side of the inner seal portion 14 has the fitting piece 15 made of an annular plate-shaped piece protruding inward in approximately parallel to the core member body 11a from the approximate center of the end face 14d in the thickness direction. In the embodiment, the fitting piece 15 is made of the same elastic material as that of the elastic seal portion 12 by integral molding.

The fitting piece 15 should fit the shaft portion 32 of the fixture 30, i.e., a bolt, so as to be provided to penetrate the space in the fitting piece 15, i.e., a circular opening 18, when the seal washer 10 is mounted. That is, the fitting piece 15 should hold the shaft portion 32, and the seal washer 10 and the bolt 30 should be temporarily fixed each other when the fitting piece 15 presses the shaft portion 32 lightly from the surroundings, when the tip end 15a of the fitting piece 15 enters the screw groove 33a of a male screw portion 33, or when the tip end 15a of the fitting piece 15 is caught on the thread 33b of the male screw portion 33. The fitting piece 15 in the embodiment of FIG. 1a is approximately semicircular in shape in order to make the tip end 15a to easily enter the screw groove 33a.

Therefore, the diameter of the opening 18 surrounded by the fitting piece 15 is approximately consistent with the diameter of the shaft portion 32 of the bolt 30 to which the seal washer 10 is attached, or is slightly smaller than the diameter of the shaft portion 32. The fitting by the fitting piece 15 can be executed for a neck portion 34 or a non-threaded portion of the shaft portion 32.

The fitting piece 15 can be configured such that the tip end 15a fits the peripheral surface of the shaft portion 32 of the bolt 30 at least before the occurrence of elastic deformation of the inner seal portion 14 in the fixing work of the member to be fastened 1. As will be described later, the fitting of the seal washer 10 (the fitting piece 15) and the bolt 30 (the shaft portion 32) can be released while the member to be fastened 1 is gradually fixed to an attachment member 20 by the bolt 30.

Thus, the fitting piece 15 should be configured such that the bolt 30 and the seal washer 10 are temporarily integrated at least at the stage prior to fixing the member to be fastened 1 to the attachment member 20. That is, according to such a temporary integration, a pair of members such as the bolt 30 and the seal washer 10 are handled as one integrated member in a temporarily integrated state, and as a result, the paired members are prevented from being separated in storage and during transportation and one of them is prevented from being lost before using the pair of members.

Further, each of the core member 11, the outer seal portion 13, the inner seal portion 14, and the fitting piece 15 of the seal washer 10 in the drawings is in a symmetrical shape on the front and back, and the seal washer 10 as a whole is also a symmetrical shape on the front and back.

The outer seal portion 13 is respectively fixed on both surfaces, i.e., the surface on the fixture side and the surface on the member to be fastened side, in the thickness direction of the seal base 11b in a separate state. As shown in FIG. 1b and FIG. 1c, an outer seal portion 13a (on the fixture side) protrudes further than the surface on the fixture side 11aa of the core member body 11a, and an outer seal portion 13b (on the member to be fastened side) protrudes further than the surface on the member to be fastened 11ab side of the core member body 11a.

Further, the inner seal portion 14 includes an inner seal body 14a, a convex portion on the fixture side 14b on the fixture side of the inner seal body 14a, the convex portion on the fixture side 14b protruding further than the surface on the fixture side 11aa of the core member body 11a, and a convex portion on the member to be fastened side 14c on the member to be fastened side of the inner seal body 14a, the convex portion on the member to be fastened side 14c protruding further than the surface on the member to be fastened side 11ab of the core member body 11a.

In the degree of protrusion in the thickness direction of the outer seal portion 13 and the inner seal portion 14, the degree of protrusion of the inner seal portion 14 is slightly larger than the degree of protrusion of the outer seal portion 13 in the figures; however, the embodiment is not limited to such a configuration.

The seal washer 10 should be integrally molded with the core member 11, the elastic seal portion 12, and the fitting piece 15 by two-color molding, i.e., a coinjection molding, using an injection mold, but the core member 11 can be retrofitted with a separately formed elastic seal portion 12 and the fitting piece 15. Since the figure shows an example of two-color molding, the inner seal portion 14 and the outer seal portion 13 are coupled by a connection portion 12a appeared on the front and back surfaces, referring to FIG. 1a and FIG. 1c.

As shown in FIG. 2, the bolt 30 and the seal washer 10 are used to fix the plate-shaped member to be fastened 1 having the insertion hole 2 for inserting the shaft portion 32 of the bolt 30 to the attachment member 20 having a female screw portion 21, i.e., an embedded nut portion.

That is, the male screw portion 33 of the shaft portion 32 of the bolt 30, referring to the enlarged view in FIG. 1a, is in a screwing relationship with the female screw portion 21 of the attachment member 20, and the member to be fastened 1 is fixed so as to be held between the fastening portion 31, i.e., the bolt head of the bolt 30, and the attachment member 20. The seal washer 10 is provided between the back surface of the bolt head 31 and the front surface of the member to be fastened 1.

FIG. 2 shows a condition under fixing operation when the male screw portion 33 of the bolt 30 and the female screw portion 21 of the attachment member 20 are in a screwed state and the seal washer 10 is held between the bolt head 31 and the member to be fastened 1. FIG. 3 shows that the bolt 30 is further screwed from the state of FIG. 2 and the member to be fastened 1 is fixed to the attachment member 20.

In the mounting structure of the seal washer 10, the dimensional relationship of three parts, i.e., the seal washer 10, the member to be fastened 1, and the bolt 30, is referred to as the following relational equation. The dimension, the inner dimension, and the outer dimension in each relational equation are radii, that is, they are measured from the central axis L, referring to FIG. 2.
the inner dimension r1 of the outer seal portion 13>the outer dimension r2 of the bolt head 31
the inner dimension r1 of the outer seal portion 13>the dimension r3 of the insertion hole 2 of the member to be fastened 1
the dimension r3 of the insertion hole 2 of the member to be fastened 1>the inner dimension r4 of the core member 11 (the outer dimension of the inner seal portion 14)
the outer dimension r2 of the bolt head 31>the inner dimension r4 of the core member 11

The relationship between the outer dimension r2 of the bolt head 31 and the dimension r3 of the insertion hole 2 is not defined, but r2 is larger than r3 in the figure.

The relational equation shows that the outer seal portion 13 does not come into contact with the bolt head 31 on the front surface side, namely there is a space on the front surface side of the outer seal portion 13, the back surface of the outer seal portion 13 comes into contact with the front surface of the member to be fastened 1, the front surface of the inner seal portion 14 comes into contact with the back surface of the bolt head 31, and the back surface of the inner seal portion 14 faces the space of the insertion hole 2.

In the state of FIG. 2 in which the bolt 30 and the attachment member 20 are screwed, the outer seal 13b (on the member to be fastened side) of the outer seal portion 13 is in contact with the front surface 1a of the member to be fastened 1, while the convex portion on the fixture side 14b of the inner seal portion 14 is in contact with the back surface of the bolt head 31. Then, by further proceeding the screwing, all members are fixed with each other, namely the screwing does not further proceed like FIG. 3.

In the state of FIG. 3, the outer seal 13b (on the member to be fastened side) of the outer seal portion 13 elastically comes into contact with the surface 1a of the member to be fastened 1 and is compressed. At this time, the shape of the outer seal 13a (on the fixture side) does not change compared with the state of FIG. 2.

In the elastic contact state, the outer seal 13b (on the member to be fastened side) of the outer seal portion 13 is supported from the side of the fixture by the seal base portion 11b in the thickness direction of the seal washer 10, so that the reaction force such as elastic contact force and elastic reset force increases, and as a result, the outer seal portion 13 of the seal washer 10 comes into tight contact with the surface 1a of the member to be fastened 1.

In this way, the seal washer 10 suppresses intrusion of moisture into the insertion hole 2 from the entire periphery of the annular portion around the insertion hole 2 and plays the role of a seal.

On the other hand, the convex portion on the fixture side 14b of the inner seal portion 14 is in contact with the back surface of the bolt head 31, and at the same time, the entire inner seal portion 14 is pressed by the bolt 30 toward the space side of the insertion hole 2 and elastically deforms, and a part thereof enters the insertion hole 2.

The inner seal portion 14 is not supported by a core, i.e., the seal base portion 11b, like the outer seal 13b (on the member to be fastened side) of the outer seal portion 13. Thus, the elastic reset force due to pressing is generated only a little, the reaction force is small, and the deformation of the inner seal portion 14 is larger than that of the outer seal 13b (on the member to be fastened side) of the outer seal portion 13, and inclines toward the space of the insertion hole 2. Therefore, the insertion hole 2 is provided as an escape space of the inner seal portion 14.

Then, along with the inclination of the inner seal portion 14 toward the insertion hole 2, the convex portion on the fixture side 14b of the inner seal portion 14 elastically deforms by pressing of the back surface of the bolt head 31, and the front surface becomes approximately the same level with the surface on the fixture side 11aa of the core member body 11a, and the bolt head 31 is in approximately uniform contact with the core member 11, referring to FIG. 3.

In this way, the gap S formed between the bolt head 31 and the seal washer 10 in the state of FIG. 2 is almost disappeared. Since the gap S almost disappears in this way, water intrusion from the surface side of the seal washer 10 is also suppressed.

The outer seal portion 13 is provided outside the bolt head 31 and does not come into direct contact with the bolt 30, so that the outer seal portion 13 does not form an elastic contact relationship with the bolt 30 and the outer seal portion 13 does not suppress water intrusion from the surface side of the seal washer 10. Instead, the inner seal portion 14 acts as mentioned above, so that intrusion of water from the surface side is prevented.

Further, as shown in FIG. 2, the seal washer 10 is held between the member to be fastened 1 (on the attachment member 20) and the bolt head 31 so as to be in contact with each other, and even if a large reaction force by the outer seal portion 13 is continuously generated, the inner seal portion 14 inclines into the insertion hole 2 which is an escape space, thereby proceeding screwing of the bolt 30 smoothly.

Thus, by providing the inner seal portion 14 inside the radial direction of the insertion hole 2 of the member to be fastened 1, operation becomes easy at the end of fastening the bolt 30 without requiring a large force, and as a result, fastening of the bolt 30 is completed smoothly.

In the present embodiment, in order to smoothly incline the inner seal portion 14 into the insertion hole 2, the outer seal portion 13 is provided outward the bolt head 31 as described above, and the outer seal portion 13 is configured so as not to interfere with the operation of the inner seal portion 14 in relation to the bolt head 31. The embodiment is not limited to the relationship in which the inner dimension r1 of the outer seal portion 13 is larger than the outer dimension r2 of the bolt head 31.

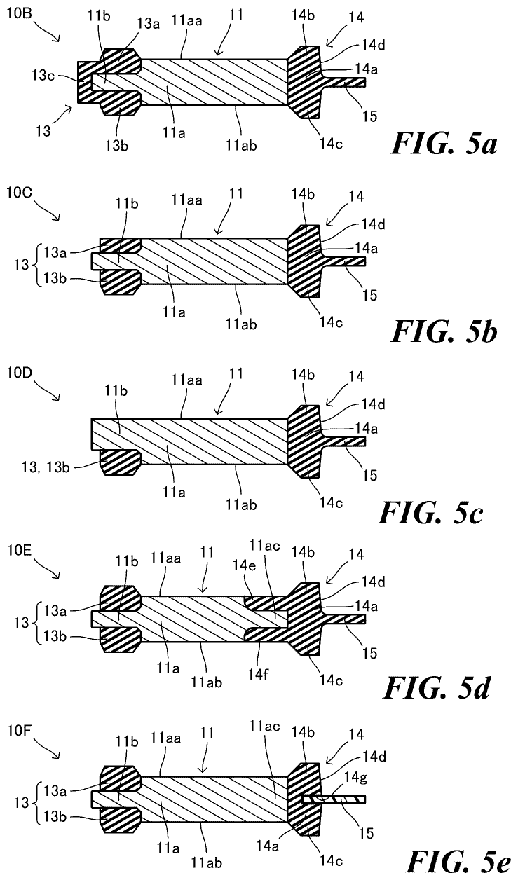

In order to realize smooth inclination of the inner seal portion 14 into the insertion hole 2, at least a mutual relationship should exist such that the outer seal portion 13 does not have an elastic contact relationship with the bolt head 31. This relationship will be described later with the description of FIG. 5b and FIG. 5c.

Further, when the inner seal portion 14 inclines into the insertion hole 2, the fitting of the fitting piece 15 with the shaft portion 32 is released as shown in the enlarged views of FIG. 2 and FIG. 3. As a result, the reaction force due to the fitting of the fitting piece 15 and the shaft portion 32 disappears, thereby facilitating screwing of the bolt 30, and avoiding corotation of the seal washer due to the rotation of the bolt 30.

In addition, in order to exhibit the original function of the fitting piece 15, i.e., the temporary integration of the bolt 30 and the seal washer 10, the reaction force due to the fitting of the fitting piece 15 and the shaft portion 32 can be adequately smaller than the reaction force of the outer seal portion 13. In such a fitting of weak force, there is no problem even if the fitting is not released when the bolt 30 proceeds screwing.

Further, the seal washer 10 shown in FIG. 1a has a symmetrical shape in the thickness direction, that is, there is almost no distinction between the surface on the fixture side and the surface on the member to be fastened side. Therefore, the seal washer 10 is used without worrying about the front and back.

As described above, in order to maintain a high sealing property and to smoothly fix the member to be fastened 1 by screwing with the bolt 30, the dimension relationship of the three members, i.e., the seal washer 10, the member to be fastened 1, and the bolt 30, should be established.

That is;
the inner dimension r1 of the outer seal portion 13>the outer dimension r2 of the bolt head 31
the inner dimension r1 of the outer seal portion 13>the dimension r3 of the insertion hole 2 of the member to be fastened 1
the dimension r3 of the insertion hole 2 of the member to be fastened 1>the inner dimension r4 of the core member 11, i.e., the outer dimension of the inner seal portion 14
the outer dimension r2 of the bolt head 31>the inner dimension r4 of the core member 11

The mounting structure of the seal washer 10A shown in FIG. 4a also satisfies the above-mentioned relational equation. In the example of the figure, the dimension r3 of the insertion hole 2 of the member to be fastened 1 is larger than that of FIG. 1a, but the relational equation is satisfied, thereby achieving the similar effect as that of FIG. 1a.

As shown in the figure, the outer dimension r2 of the bolt head 31 and the dimension r3 of the insertion hole 2 can be related such that r2 is equal to or less than r3, that is, even when the member to be fastened 1 of which dimension r3 of the insertion hole 2 is larger than the outer dimension r3 of the bolt head 31 is attached to be fixed, the similar advantageous effect as the one shown in FIG. 1a is achieved.

Further, the seal washer 10A shown in FIG. 4a differs from the one shown in FIG. 1a in that the outer seal portion 13 includes only the outer seal 13b (on the member to be fastened side), namely the outer seal 13a (on the fixture side) does not exist, and the inner seal portion 14 does not have the convex portion on the member to be fastened side 14c.

Such a seal washer 10A does not have particular problem in the elastic contact of the outer seal portion 13 to the member to be fastened 1, the inclination of the inner seal portion 14 into the insertion hole 2, and the surface leveling of the convex portion on the fixture side 14b and the core member body 11a. The seal washer 10A achieves the similar advantageous effect as that of the seal washer 10 in FIG. 1a.

The shapes of the seal washers 10 and 10A are not limited to those of FIG. 1a and FIG. 4a, and can be seal washers 10B to 10F shown in FIG. 5a to FIG. 5e according to another embodiment.

In the seal washer 10B of FIG. 5a, the outer seal portion 13 includes the outer seal 13a (on the fixture side) and the outer seal 13b (on the member to be fastened side), and further includes a connection portion 13c which couples the outer seal 13a (on the fixture side) and the outer seal 13b (on the member to be fastened side). The connection portion 13c is provided so as to cover the end face on the outer periphery side of the seal base portion 11b.

The outer seal 13b (on the member to be fastened side) protrudes further than the surface on the member to be fastened side 11ab of the core member body 11a, and the outer seal 13a (on the fixture side) protrudes further than the surface on the fixture side 11aa of the core member body 11a. Further, the inner seal portion 14 is almost the same as that of FIG. 1a.

Since the outer seal portion 13 has the connection portion 13c and the front side and the back side are integrated, it is easy to retrofit the outer seal portion 13 molded separately from the core member 11 to the core member 11. For example, when the outer seal portion 13 is made of an elastic material different from that of the inner seal portion 14, or when the protruding degree of the outer seal portion 13 to the member to be fastened 1 side is varied depending on the type and the like of the member to be fastened 1 and a plurality of outer seal portions 13 are provided so as to be replaceable, the integrated outer seal portion 13 is useful.

In the seal washer 10C of FIG. 5b, the outer seal portion 13 includes an outer seal 13a (on the fixture side) and an outer seal 13b (on the member to be fastened side), and the surface of the outer seal 13a (on the fixture side) is approximately on the same level with the surface on the fixture side 11aa of the core member body 11a. The outer seal 13b (on the member to be fastened side) protrudes further than the surface on the member to be fastened side 11ab of the core member body 11a.

Since the outer seal portion 13 has such a shape, the amount of elastic material is reduced. Further, since the surface outside the inner seal portion 14 is approximately flat, even if the bolt 30 of which bolt head 31 covers the outer seal portion 13 from above is used, there is almost no risk that the outer seal 13a (on the fixture side) comes into elastic contact with the bolt head 31 in the fixing work of the member to be fastened 1, and the inclination of the inner seal portion 14 into the insertion hole 2 is smoothly achieved. The inner seal portion 14 is similar to that of FIG. 1a.

In the seal washer 10D of FIG. 5c, the outer seal portion 13 does not include the outer seal 13a (on the fixture side), and includes only the outer seal 13b (on the member to be fastened side) protruding further than the surface on the member to be fastened side 11ab of the core member body 11a. The surface of the seal base on the fixture side 11b is formed approximately at the same level as the surface on the fixture side 11aa of the core member body 11a.

In this way, since the outer seal portion 13 is made only by the outer seal 13b (on the member to be fastened side), the amount of the elastic material is reduced. Further, since the outer seal 13a (on the fixture side) does not exist and the surface outside the inner seal portion 14 is almost flat, even if the bolt 30 of which bolt head 31 covers the outer seal portion 13 from above is used, there is almost no risk that the outer seal portion 13 comes into elastic contact with the bolt head 31 in the fixing work of the member to be fastened 1, and the inclination of the inner seal portion 14 into the insertion hole 2 is smoothly achieved. The inner seal portion 14 is similar to that of FIG. 1a.

Thus, in the relationship between the seal washer 10 and the bolt 30, the seal washers 10C and 10D shown in FIG. 5b and FIG. 5c are not required to have the dimensional relationship such that the inner dimension r1 of the outer seal portion 13 is larger than the outer dimension r2 of the bolt head 31 as shown in FIG. 2.

Thus, even when the seal washers 10C and 10D are used for the bolt 30 of which bolt head 31 covers the outer seal portion 13 from above, the inner seal portion 14 inclines into the insertion hole 2 smoothly.

The seal washer 10E of FIG. 5d has the similar outer seal portion 13 to that of FIG. 1a, and includes the outer seal 13a (on the fixture side) and the outer seal 13b (on the member to be fastened side).

Further, the core member body 11a of the core member 11 includes a held portion 11ac, i.e., a portion to be held, to couple the inner seal portion 14 to the end portion on the inner circumference side. The thickness of the held portion 11ac is about ⅓ of the core member body 11a, is an annular plate piece similar to the seal base portion 11b, and is provided so as to extend inward from the approximate center of the inner peripheral end of the core member body 11a in the thickness direction. The inner seal body 14a, the convex portion on the fixture side 14b, and the convex portion on the member to be fastened side 14c are provided on the inner peripheral side further than the held portion 11ac.

The inner seal portion 14 includes a holding piece on the fixture side 14e and a holding piece on the member to be fastened side 14f in addition to the inner seal body 14a, the convex portion on the fixture side 14b, and the convex portion on the member to be fastened side 14c. The inner seal portion 14 is fixed to the core member body 11a in such a manner that the holding piece on the fixture side 14e and the holding piece on the member to be fastened side 14f hold the held portion 11ac of the core member body 11a.

Since the inner seal portion 14 includes a pair of holding pieces on the front and back sides, when the inner seal portion 14 is separately molded, it is easy to retrofit the inner seal portion 14 to the core member 11. For example, such an inner seal portion 14 is facilitated when the inner seal portion 14 is made of an elastic material different from the outer seal portion 13, or when the protruding degree of the inner seal portion 14 to the fixture 30 side varies depending on the type of fixture 30 and the like.

The held portion 11ac of the core member body 11a has a different function from the seal base 11b, and does not support the elastic contact like the seal base 11b which is provided behind the elastic material. However, by making various different holding modes by adjusting the thickness of the holding piece, the degrees of inclination of the inner seal portion 14, i.e., the inner seal body 14a, the convex portion on the fixture side 14b, and the convex portion on the member to be fastened side 14c can be varied.

The seal washer 10F of FIG. 5e is approximately the same as the one in FIG. 1a as an overall silhouette, but is different from the one in FIG. 1a in that the fitting piece 15 is separately molded and the material of the fitting piece 15 is not an elastic material constituting the inner seal portion 14.

The fitting piece 15 is an annular plate piece made of a synthetic resin material such as rigid PET having higher rigidity than the material of the inner seal portion 14. The annular plate piece is inserted into an insertion groove 14g provided on the end face 14d on the inner periphery side of the inner seal body 14a of the inner seal portion 14 and acts as the fitting piece 15.

The fitting piece 15 in FIG. 5a is less elastic than the fitting piece 15 adopted in FIG. 1a and the like, and the elastic deformation of the fitting piece 15 itself during elastic deformation of the inner seal portion 14 is smaller than that of the inner seal portion 14. The entire inner seal portion 14 warps so as to be inclined into the insertion hole 2, the fitting is released accordingly, and the fitting piece 15 inclines as illustrated in FIG. 3.

Since the fitting piece 15 is separately molded in this way, the fitting piece 15 is replaceable so as to match the diameter of the shaft portion 32 of the bolt 30 by making various fitting pieces 15 in different dimensions.

In addition, the mounting structures of the seal washers 10B to 10F according to the five examples shown in FIG. 5a, that is, the mounting structures for the bolt 30 and the member to be fastened 1, are omitted. In these seal washers 10B to 10F, the above-described relational equation should be established in the relationship between the dimensions r1 and r4 of each part, the dimension r3 of the insertion hole 2 of the member to be fastened 1, and the dimension r2 of the bolt head 31. As described above, with respect to the seal washers 10B and 10C shown in FIG. 5b and FIG. 5c, the relationship such that the inner dimension r1 of the outer seal portion 13 is larger than the outer dimension r2 of the bolt head 31 is not required to be established.

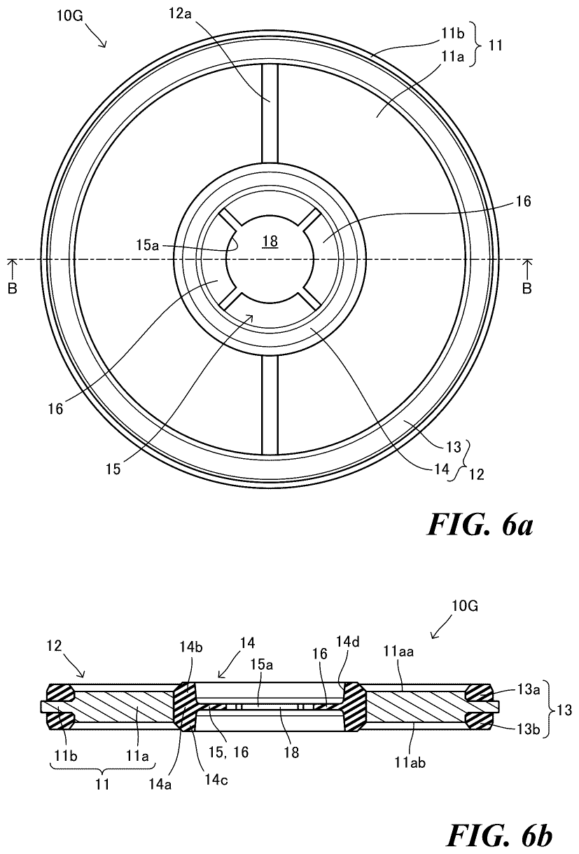

Further, as shown in FIG. 6a, a seal washer 10G in which the fitting piece 15 is formed intermittently along the circumferential direction, that is, the fitting piece 15 includes a plurality of separate pieces 16, can also be used.

If the fitting piece 15 is formed intermittently along the circumferential direction in this way, the fitting of the bolt 30 to the shaft portion 32 is easily released as the screwing of the bolt 30 proceeds, so that the reaction force of the fitting piece 15 is reduced, thereby achieving facilitation. In particular, if a separately molded hard separation piece 16 is used, it is convenient that the fitting is easily released due to the separation. Further, in the case of the separately molded fitting piece 15, it is convenient because the fitting piece 15 is constituted with the separate piece 16.

Since the configuration of the seal washer 10G of FIG. 6a is generally similar to that of FIG. 1a except for the shape and configuration of the fitting piece 15, the same component is given with the same reference numerals in FIG. 6a, and the explanation is omitted.

In the above embodiments, an example in which the fastening portion 31 of the fixture 30 is the bolt head 31 is shown, but the fastening portion 31 can be a nut or a ring washer. That is, the seal washers 10, 10A to 10G can be provided between the nut or the ring washer and the member to be fastened 1.

Further, the female screw portion 21 of the attachment member 20 can be a female screw portion formed by burring process instead of the embedded nut portion. The seal washers 10, 10A to 10G and the mounting structures of the seal washers 10, 10A to 10G according to the embodiments described above are only an example, and it goes without saying that configurations and shapes other than the examples shown in the figures can be appropriately changed.

### DESCRIPTION OF THE REFERENCE NUMERAL

1 member to be fastened
1a surface
2 insertion hole
10, 10A˜10G seal washer
11 core member
11a core member body
11aa surface on fixture side
11ab surface on member to be fastened side
11b seal base
12 elastic seal portion
12a connection portion
13 outer seal portion
13a outer seal (on fixture side)
13b outer seal (on member to be fastened side)
14 inner seal portion
14a inner seal body
14b convex portion on fixture side
14c convex portion on member to be fastened side
14d end face on inner peripheral side
15 fitting piece
15a tip end
16 separation piece
20 attachment member
21 female screw portion (embedded nut portion)
30 fixture (bolt)
31 fastening portion (bolt head)
32 shaft portion
r1 inner dimension of outer seal portion
r2 outer dimension of fastening portion (bolt head)
r3 dimension of insertion hole of member to be fastened
r4 inner dimension of core member

What is claimed is:

1. A seal washer to be provided in a space between a fastening portion of a fixture and a member to be fastened, the fixture comprising the fastening portion and a shaft portion, the member to be fastened having an insertion hole through which the shaft portion is inserted,
the seal washer comprising an annular core member, an outer seal portion made of an elastic material and fixed to an end portion of the core member on an outer peripheral side, and an inner seal portion made of an elastic material and fixed to an end portion of the core member on an inner peripheral side, and
the core member comprising a core member body and a seal base extending to an outer peripheral side from the core member body,
wherein the outer seal portion is provided on one of two surfaces of the seal base in thickness direction so as to protrude further than a surface of the core member body, the one surface facing the member to be fastened,
wherein the inner seal portion is provided at an end face of the core member body on an inner peripheral side so as to further protrude inward and to protrude further than a surface of the core member body toward the fastening portion, and
wherein an inner diameter of the outer seal portion is larger than a diameter of the insertion hole, a diameter of the insertion hole is larger than an inner diameter of the core member, and an outer diameter of the fastening portion is larger than the inner diameter of the core member.

2. The seal washer according to claim 1 further comprising a fitting piece protruding inward from an end face of the inner seal portion on an inner peripheral side,
wherein the fitting piece is in a shape of a plate which is thinner than the inner seal portion and a tip end of the fitting piece is fitted to a peripheral surface of the shaft portion at least when the inner seal portion is not elastically deformed.

3. The seal washer according to claim 2, wherein the fitting piece is intermittently formed along a peripheral direction.

4. The seal washer according to claim 1, wherein the shaft portion comprises a screw groove and a tip end of the fitting piece is fitted to the screw groove.

5. The seal washer according to claim 2, wherein the shaft portion comprises a screw groove and a tip end of the fitting piece is fitted to the screw groove.

6. The seal washer according to claim 3, wherein the shaft portion comprises a screw groove and a tip end of the fitting piece is fitted to the screw groove.

7. An attachment structure of the seal washer according to claim 1, wherein the seal washer is provided in a space between a fastening portion of a fixture and a member to be fastened, the fixture comprising the fastening portion and a shaft portion, the member to be fastened comprising an insertion hole through which the shaft portion is inserted.

8. An attachment structure of the seal washer according to claim 2, wherein the seal washer is provided in a space between a fastening portion of a fixture and a member to be fastened, the fixture comprising the fastening portion and a shaft portion, the member to be fastened comprising an insertion hole through which the shaft portion is inserted.

9. An attachment structure of the seal washer according to claim 3, wherein the seal washer is provided in a space between a fastening portion of a fixture and a member to be fastened, the fixture comprising the fastening portion and a shaft portion, the member to be fastened comprising an insertion hole through which the shaft portion is inserted.

10. An attachment structure of the seal washer according to claim 4, wherein the seal washer is provided in a space between a fastening portion of a fixture and a member to be fastened, the fixture comprising the fastening portion and a shaft portion, the member to be fastened comprising an insertion hole through which the shaft portion is inserted.

11. An attachment structure of the seal washer according to claim 5, wherein the seal washer is provided in a space between a fastening portion of a fixture and a member to be fastened, the fixture comprising the fastening portion and a shaft portion, the member to be fastened comprising an insertion hole through which the shaft portion is inserted.

12. An attachment structure of the seal washer according to claim 6, wherein the seal washer is provided in a space between a fastening portion of a fixture and a member to be fastened, the fixture comprising the fastening portion and a shaft portion, the member to be fastened comprising an insertion hole through which the shaft portion is inserted.
